(19) United States
(12) Patent Application Publication
(10) Pub. No.: US 2025/0324941 A1
(43) Pub. Date: Oct. 23, 2025

(54) Smart Pet Feeder Device

(71) Applicant: Nicholas Fee, Defiance, OH (US)

(72) Inventor: Nicholas Fee, Defiance, OH (US)

(21) Appl. No.: 19/069,326

(22) Filed: Mar. 4, 2025

Related U.S. Application Data
(60) Provisional application No. 63/636,137, filed on Apr. 19, 2024.

(51) Int. Cl. A01K 5/02; A01K 5/01

(52) U.S. Cl. CPC A01K 5/0291; A01K 5/0114; A01K 5/0225; A01K 5/0275

(57) ABSTRACT

A smart pet feeder device is provided comprising of a housing that accommodates one or more hoppers for storing different types of pet food. Each hopper features an airtight lid, hinge, and locking mechanism to preserve food quality and prevent contamination. A motorized dispensing system, integrated within the housing, uses various mechanisms to distribute precise portions of food into corresponding bowls, managed based on customizable pet profiles accessed via a mobile application. The application facilitates scheduling and portion control, employing wireless communication for remote operation. An AI-driven system, aided by a high-resolution camera, identifies pets using image recognition, ensuring the correct food is dispensed. Embedded sensors in the bowls measure and monitor food portions, while a funnel design minimizes waste, redirecting uneaten food into storage if detected by additional sensors. The device also includes two-way audio communication for interaction and is powered by batteries, with an optional corded power supply.

### CROSS-REFERENCE TO RELATED APPLICATION

The present application claims priority to, and the benefit of, U.S. Provisional Application No. 63/636,137, which was filed on Apr. 19, 2024, and is incorporated herein by reference in its entirety.

### FIELD OF THE INVENTION

The present invention relates generally to the field of animal feeders. More specifically, the present invention relates to a smart pet feeder device that provides a feeder that allows for scheduled feeding of different types and amounts of pet food. Accordingly, the present disclosure makes specific reference thereto. Nonetheless, it is to be appreciated that aspects of the present invention are also equally applicable to other like applications, devices, and methods of manufacture.

### BACKGROUND

Many pets have a tendency to overeat, which can lead to obesity and a range of associated health problems such as diabetes, joint issues, and heart disease. These conditions can significantly impact a pet's quality of life and longevity. Conversely, pets may not receive adequate nutrition if their feeding schedule is inconsistent or if multiple members of a household share the responsibility of feeding, potentially leading to confusion or missed meals. An irregular feeding routine can be stressful for pets, as they thrive on predictability and consistency in their daily lives. By using a controlled feeder, pet owners can establish a reliable and structured feeding schedule, which can positively impact their pets' overall health, well-being, and behavior. Pets that are fed on a regular schedule tend to be calmer and experience less anxiety, as they know when to expect their meals. In multi-pet households, food competition is a common issue, as some animals may feel the need to guard or consume food quickly before another pet has the chance to eat it. This can result in one pet overeating while another goes hungry, leading to imbalanced nutrition and even behavioral problems like food aggression.

Therefore, there exists a long-felt need in the art for an improved pet feeding device. There also exists a long-felt need in the art for a smart pet feeder device. More specifically, there exists a long-felt need in the art for a smart pet feeder device that allows multiple pets to be fed multiple different types of food. There also exists a long-felt need in the art for a smart pet feeder device that allows multiple pets to be fed multiple different types of food at differing times. In addition, there exists a long-felt need in the art for a smart pet feeder device that allows multiple pets to be fed multiple different types and amounts of food at differing times.

The subject matter disclosed and claimed herein, in one embodiment thereof, comprises a smart pet feeder device. The device is comprised of a housing that accommodates one or more hoppers for storing different types of pet food. Each hopper features an airtight lid, hinge, and locking mechanism to preserve food quality and prevent contamination. A motorized dispensing system, integrated within the housing, uses various mechanisms to distribute precise portions of food into corresponding bowls, which are managed based on customizable pet profiles accessed via a mobile application. The application facilitates scheduling and portion control, employing wireless communication for remote operation. An AI-driven system, aided by a high-resolution camera, identifies pets using image recognition, ensuring the correct food is dispensed. Embedded sensors in the bowls measure and monitor food portions, while a funnel design minimizes waste, redirecting uneaten food into storage if detected by additional sensors. The device also includes two-way audio communication for interaction and is powered by batteries, with an optional corded power supply.

In this manner, the smart pet feeder device of the present invention accomplishes all the forgoing objectives and provides an improved pet feeding device. The device allows multiple pets to be fed multiple different types of food. The device also allows multiple pets to be fed multiple different types of food at differing times. In addition, the device allows multiple pets to be fed multiple different types and amounts of food at differing times.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart pet feeder device. The device is comprised of a housing that accommodates at least one hopper for storing pet food, designed to facilitate gravity-fed transfer. The housing may include multiple hoppers to store different food types, suitable for households with multiple pets needing varied diets. Airtight lids, hinges, and locking mechanisms ensure food freshness and prevent cross-contamination.

Food distribution occurs through openings in the housing, aligning with corresponding bowls. Dispensing is managed by motorized mechanisms, such as rotating augers or conveyor systems, each independently controlled for precision. This configuration enables tailored food delivery based on each pet's dietary needs and schedule.

A mobile application manages feeding schedules and portions, interfacing with a wireless communication module that supports Wi-Fi, Bluetooth, or cellular connections. The application allows users to create pet profiles containing dietary preferences and meal specifications. An AI system coordinates the dispensing mechanisms, ensuring accurate food distribution.

A mounted camera, which may be high-resolution or infrared, captures images analyzed by AI for pet recognition. The AI uses visual and biometric data, such as facial features or nose-prints, to identify pets and refine recognition accuracy. When a pet is identified, the system dispenses the correct food type and portion. The AI prioritizes feeding if multiple pets approach simultaneously, based on predefined criteria.

Embedded sensors or scales in the bowls measure food portions, providing feedback for precise dispensing and notifying the owner of discrepancies via the app. Data on food consumption is also tracked for monitoring eating habits, aiding in dietary and health management.

Bowls are funnel-shaped to reduce waste, with motorized doors that redirect uneaten food to storage compartments when sensors detect it has remained untouched for a set period. This mechanism enhances cleanliness and offers recycling options. Additionally, a built-in speaker enables two-way communication between owners and pets, controlled through the app.

The device operates on battery power, supplemented by a power cord for charging.

Accordingly, the smart pet feeder device of the present invention is particularly advantageous as it provides an improved pet feeding device. The device allows multiple pets to be fed multiple different types of food. The device also allows multiple pets to be fed multiple different types of food at differing times. In addition, the device allows multiple pets to be fed multiple different types and amounts of food at differing times. In this manner, the smart pet feeder device overcomes the limitations of existing methods and devices used for pet feeding known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a smart pet feeder device of the present invention in accordance with the disclosed architecture; and

FIG. 2 illustrates a perspective view of one potential embodiment of a smart pet feeder device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved pet feeding device. There also exists a long-felt need in the art for a smart pet feeder device. More specifically, there exists a long-felt need in the art for a smart pet feeder device that allows multiple pets to be fed multiple different types of food. There also exists a long-felt need in the art for a smart pet feeder device that allows multiple pets to be fed multiple different types of food at differing times. In addition, there exists a long-felt need in the art for a smart pet feeder device that allows multiple pets to be fed multiple different types and amounts of food at differing times.

The present invention, in one exemplary embodiment, is comprised of a smart pet feeder device. The device is comprised of a housing that holds at least one hopper for storing pet food, designed to support gravity-fed transfer. The housing may accommodate multiple hoppers for different food types, providing a solution for households with multiple pets requiring varied diets. Airtight lids, hinges, and locking mechanisms maintain food freshness and prevent cross-contamination.

Food is dispensed through housing openings aligned with designated bowls. Motorized mechanisms, such as rotating augers or conveyor systems, manage distribution, each independently controlled for precision. This arrangement allows for tailored food delivery according to each pet's dietary requirements and schedule.

A mobile application handles feeding schedules and portions, communicating with a wireless module compatible with Wi-Fi, Bluetooth, or cellular networks. Users can set up pet profiles detailing dietary needs and meal settings. An AI system controls the dispensing mechanisms, ensuring accurate food allocation.

A mounted camera, which can be high-resolution or infrared, captures images analyzed by AI to recognize pets. The AI uses visual and biometric data, like facial features or nose-prints, for identification and continuously improves recognition accuracy. Once a pet is identified, the system releases the appropriate food type and portion. If multiple pets approach simultaneously, the AI prioritizes feeding based on set criteria.

Sensors or scales embedded in the bowls measure portions, providing feedback to maintain accuracy and alerting the owner through the app if discrepancies arise. Food consumption data is tracked, supporting the monitoring of eating habits and health management.

Funnel-shaped bowls minimize waste, and motorized doors move uneaten food to storage compartments when sensors detect inactivity for a specified duration. This feature promotes cleanliness and allows recycling options. A built-in speaker facilitates two-way communication between owners and pets, controlled via the app.

The device is powered by a battery, with a power cord available for recharging.

The smart pet feeder addresses the limitations of conventional methods, enabling the feeding of multiple pets with different food types, amounts, and schedules.

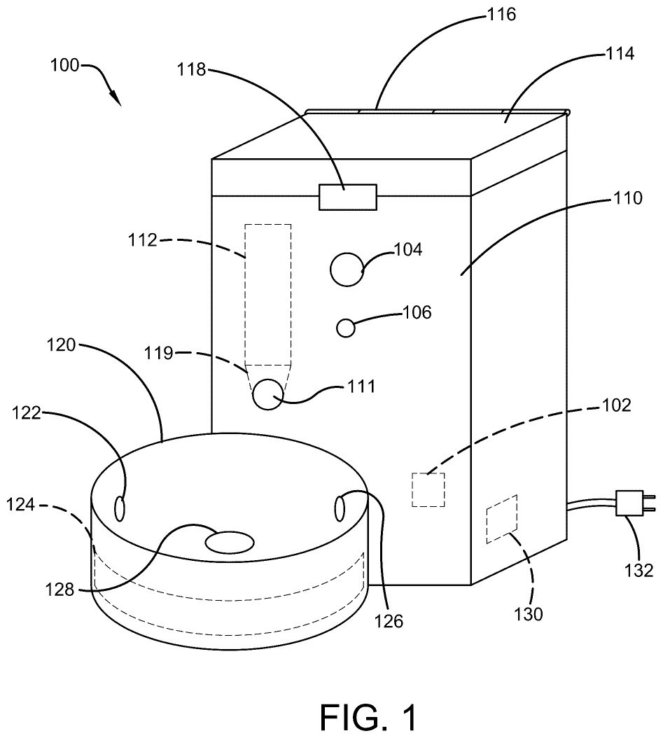

Referring initially to the drawings, FIG. 1 illustrates a perspective view of one potential embodiment of a smart pet feeder device 100 of the present invention in accordance with the disclosed architecture. The device 100 is comprised of a housing 110 that may be any shape and be made of any material. The housing 110 accommodates at least one hopper 112, designed to store pet food. The hopper 112 may be any shape that facilitates gravity-fed food transfer. In an advanced embodiment, the device 100 may feature multiple hoppers 112, each configured to hold different types of pet food. This enables tailored feeding solutions in households with multiple pets requiring varied diets. The housing 110 and/or each hopper 112 can be equipped with its own airtight lid 114, hinge 116, and locking mechanism 118 to maintain the freshness of the respective food type and prevent cross-contamination.

To facilitate the distribution of food from each hopper 112, the housing 110 is configured with at least one opening 111, aligned with at least one corresponding bowl 120. The dispensing of food from the hopper 112 is facilitated by at least one motorized dispensing mechanism 119, which may each include, but is not limited to rotating augers, conveyor systems, or vibrating feeders. These mechanisms 119 are independently controlled for each hopper 112, enabling precise and customizable food delivery for each pet. This design allows the device 100 to dispense different types and amounts of food at scheduled times based on the unique dietary needs of each pet in a multi-pet household.

The management and customization of feeding schedules and portions are handled through a mobile application 200 and/or software in wireless electrical communication with a wireless communication module 102 embedded in the device 100. The wireless communication module 102 may support various connectivity protocols, such as Wi-Fi, Bluetooth, or cellular networks, to ensure reliable remote control and monitoring.

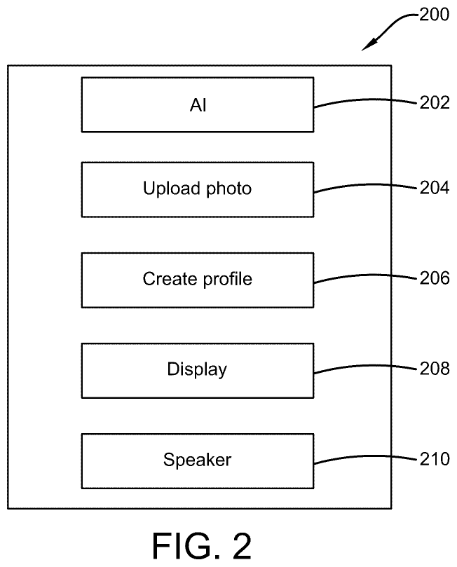

The application 200 provides an interface for users to set up and manage profiles for multiple pets, wherein functions of the mobile application 200 are displayed in FIG. 2. Each pet profile 206 contains detailed information, including but not limited to the pet's name, dietary preferences, the specific hopper 112 assigned to their food, the designated bowl 120, the exact portion size per meal (in weight or volume), meal frequency, and scheduled feeding times. The AI system 202 embedded within the application uses this information to coordinate and program the operation of each dispensing mechanism 119, ensuring that each pet receives the correct type and amount of food on the schedule needed.

A camera 104 mounted on the housing 110 may be a high-resolution color camera, infrared camera, or a dual-camera setup that functions effectively in various lighting conditions. The AI 202 uses image recognition algorithms to analyze visual data captured by the camera 104. This visual analysis allows the AI 202 to identify individual pets and ensure that food is dispensed to the correct bowl 120.

The identification process begins when the camera 104 detects movement or the presence of a pet near the device 100. The AI 202 compares the visual data to the stored appearance profile of each registered pet, which may include facial features, fur patterns, size, and posture. The AI 202 continuously refines its recognition accuracy using machine learning, adapting to changes such as fur growth, weight fluctuations, or coloration alterations. In some embodiments, the AI 202 can use a pet's nose-print as a biometric identifier, providing an even more precise method of distinguishing between pets.

Once the AI 202 confirms the identity of a pet, it cross-references the pet's profile 206 to determine the correct hopper 112 and bowl 120, as well as the specified portion size and food type. This ensures that the motorized dispensing mechanism 119 delivers the appropriate amount and type of food to the designated bowl 120. If multiple pets approach the feeding station simultaneously, the AI 202 prioritizes based on feeding schedules or other user-defined criteria, ensuring that there is no misallocation of food.

The bowls 120 may also feature embedded sensors 122 or scales that measure the weight of the food dispensed, ensuring precise portioning as defined in the pet profiles 206. These sensors 122 provide feedback to the AI 202, which can adjust future portions or notify the owner via the mobile application 200 if there are discrepancies, such as leftover food or unaccounted consumption.

The application 200 may also display data such as the weight of food eaten 208, helping owners track and monitor each pet's eating habits over time. This feature is particularly valuable for health management, especially for pets with specific dietary restrictions or weight management goals.

The bowls 120 are preferably funnel-shaped to minimize food waste and redirect any uneaten food into integrated removable storage compartments 124. Additionally, each bowl 120 can be equipped with at least one sensor 126, such as an infrared or ultrasonic sensor, to detect the presence of uneaten food. If a sensor 126 detects that food has remained in the bowl 120 for a predefined duration (e.g., 10-15 minutes), a motorized door 128 opens, allowing the food to drop into the storage compartment 124. This feature ensures cleanliness and provides the option for the pet owner to recycle the food into the appropriate hopper 112.

Finally, the housing 110 may also comprise a speaker 106, enabling two-way audio communication. Owners can use the application 200 to speak 210 to their pets, providing comfort or issuing feeding-related commands, enhancing the overall utility and functionality of the device 100 for multi-pet households.

The device 100 is preferably powered by at least one battery which receives power from at least one power cord 132.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “smart pet feeder device” and “device” are interchangeable and refer to the smart pet feeder device 100 of the present invention.

Notwithstanding the forgoing, the smart pet feeder device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the smart pet feeder device 100 as shown in the FIGS. are for illustrative purposes only, and that many other sizes and shapes of the smart pet feeder device 100 are well within the scope of the present disclosure. Although the dimensions of the smart pet feeder device 100 are important design parameters for user convenience, the smart pet feeder device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart pet feeder device comprising:
a housing;
a hopper disposed within the housing, wherein the hopper is comprised of an airtight lid, a hinge, and a locking mechanism;
a motorized dispensing mechanism operatively associated with the hopper, the motorized dispensing mechanism configured to dispense a pet food from the hopper through an opening in the housing to at a bowl;
a wireless communication module configured to facilitate remote control and monitoring of the smart pet feeder device via a mobile application; and
a camera mounted on the housing.

2. The smart pet feeder device of claim 1, wherein the motorized dispensing mechanism is comprised of a rotating auger.

3. The smart pet feeder device of claim 1, wherein the motorized dispensing mechanism is comprised of a conveyor system.

4. The smart pet feeder device of claim 1, wherein the motorized dispensing mechanism is comprised of a vibrating feeder.

5. The smart pet feeder device of claim 1, wherein the wireless communication module is comprised of a Wi-Fi, a Bluetooth, or a cellular module.

6. The smart pet feeder device of claim 1 further comprised of a speaker.

7. The smart pet feeder device of claim 1, wherein the camera uses an image recognition algorithms to identify individual pets based on a facial feature, a fur pattern, or a body posture.

8. The smart pet feeder device of claim 1 comprised of an artificial intelligence.

9. A smart pet feeder device comprising:
a housing configured to accommodate a hopper comprised of an airtight lid, a hinge, and a locking mechanism;
a motorized dispensing mechanism operatively associated with the hopper, the motorized dispensing mechanism configured to dispense a food from the hopper through an opening in the housing to a bowl attached to the housing;
a wireless communication module configured for remote control and monitoring of the smart pet feeder device via a mobile application, wherein the mobile application is configured to manage a pet profile and customize a feeding schedule; and
a camera mounted on the housing, the camera configured to capture a visual data to identify an individual pet and facilitate food dispensing to the bowl.

10. The smart pet feeder device of claim 9, wherein the bowl is comprised of a funnel-shape.

11. The smart pet feeder device of claim 9, wherein the bowl is comprised of an ultrasonic sensor.

12. The smart pet feeder device of claim 9, wherein the bowl is comprised of a storage compartment.

13. The smart pet feeder device of claim 9, wherein the bowl is comprised of a motorized door.

14. The smart pet feeder device of claim 9 further comprised of an artificial intelligence that coordinates dispensing of the food based on the visual identification of the individual pet and a scheduled feeding time.

15. A smart pet feeder device comprising:
a housing comprised of a hopper, the hopper comprised of an airtight lid, a hinge, and a locking mechanism;
a motorized dispensing mechanism configured to dispense a food from the hopper through an opening in the housing to a bowl, the bowl comprised of a sensor;
a wireless communication module embedded in the housing, configured to communicate with a mobile application;
a mobile application configured to manage a pet profile, set a feeding schedule, and receive a feedback from the weight sensor feedback; and
a camera mounted on the housing.

16. The smart pet feeder device of claim 15 further comprised of a battery.

17. The smart pet feeder device of claim 15 further comprised of a power cord.

18. The smart pet feeder device of claim 15, wherein the motorized dispensing mechanism is configured to dispense a varying amount of the food based on an input from the mobile application.

19. The smart pet feeder device of claim 15, wherein the sensor is comprised of a weight sensor.

20. The smart pet feeder device of claim 15, wherein the sensor is comprised of an infrared sensor.
